(19) United States
(12) Patent Application Publication
(10) Pub. No.: US 2026/0177363 A1
(43) Pub. Date: Jun. 25, 2026

(54) NON-LETHAL ANTI-INTRUSION DEVICE AND COMPREHENSIVE TRAINING SYSTEM FOR EDUCATIONAL AND CHILDCARE SETTINGS USING A 5-POUND CO2 FIRE EXTINGUISHER

(71) Applicant: David Vitalli, Brentwood, TN (US)

(72) Inventor: David Vitalli, Brentwood, TN (US)

(21) Appl. No.: 18/990,765

(22) Filed: Dec. 20, 2024

(51) Int. Cl. F42B 12/36; A62C 13/64

(52) U.S. Cl. CPC F42B 12/36; A62C 13/64

(57) ABSTRACT

A comprehensive non-lethal defense system using a 5-pound CO2 fire extinguisher and detailed training protocols is provided. The defense system includes a standard fire extinguisher that is repurposed for threat mitigation. The defense system also includes a frost-free horn that Prevents frostbite on the hands of the user during operation the standard fire extinguisher. The defense system also includes a trigger mechanism with a safety lock that allows for controlled bursts and prevents accidental discharge from the standard fire extinguisher. The defense system also includes an ergonomic handle that ensures secure grip and stability under stress corresponding the standard fire extinguisher.

### CROSS-REFERENCES TO RELATED APPLICATIONS

N/A.

### FIELD OF THE TECHNOLOGY

The present disclosure generally relates to a re-purposing of a standard 5-pound CO2 fire extinguisher into a defensive weapon and, more specifically, to training modules for self-defense using a fire extinguisher.

### DESCRIPTION OF THE RELATED ART

Schools and childcare centers are increasingly vulnerable to both external and internal threats, including active shooters and confrontations with combative parents. In such environments, firearms are often prohibited, necessitating practical, non-lethal alternatives. A CO2 fire extinguisher offers an immediate, legal, and effective way to incapacitate a threat, allowing staff to evacuate or secure children safely. Staff training ensures proper deployment and minimizes risks of injury during critical incidents.

What is needed is a method and a system for repurposing a 5-pound CO2 fire extinguisher as a non-lethal anti-intrusion device, complemented by integrated training protocols for use in various emergency situations.

### SUMMARY

In an embodiment, a system includes a comprehensive non-lethal defense system using a 5-pound CO2 fire extinguisher and detailed training protocols. The defense system includes a standard fire extinguisher that is repurposed for threat mitigation. The defense system also includes a frost-free horn that prevents frostbite on the hands of the user during operation the standard fire extinguisher. The defense system also includes a trigger mechanism with a safety lock that allows for controlled bursts and prevents accidental discharge from the standard fire extinguisher. The defense system also includes an ergonomic handle that ensures secure grip and stability under stress corresponding the standard fire extinguisher.

In another embodiment, a device includes a comprehensive non-lethal defense system using a 5-pound CO2 fire extinguisher and detailed training protocols. The defense system includes a standard fire extinguisher that is repurposed for threat mitigation. The defense system also includes a frost-free horn that prevents frostbite on the hands of the user during operation the standard fire extinguisher. The defense system also includes a trigger mechanism with a safety lock that allows for controlled bursts and prevents accidental discharge from the standard fire extinguisher. The defense system also includes an ergonomic handle that ensures secure grip and stability under stress corresponding the standard fire extinguisher.

In still another embodiment, a comprehensive non-lethal defense system using a 5-pound CO2 fire extinguisher and detailed training protocols is provided. The defense system includes a standard fire extinguisher that is repurposed for threat mitigation. The defense system also includes a frost-free horn that prevents frostbite on the hands of the user during operation the standard fire extinguisher. The defense system also includes a trigger mechanism with a safety lock that allows for controlled bursts and prevents accidental discharge from the standard fire extinguisher. The defense system also includes an ergonomic handle that ensures secure grip and stability under stress corresponding the standard fire extinguisher.

### BRIEF DESCRIPTION OF THE DRAWINGS

The present invention is described in detail below with reference to the attached drawing figures, which are incorporated by reference herein and wherein:

FIG. 1 is a block diagram illustrating an exemplary embodiment of the invention;

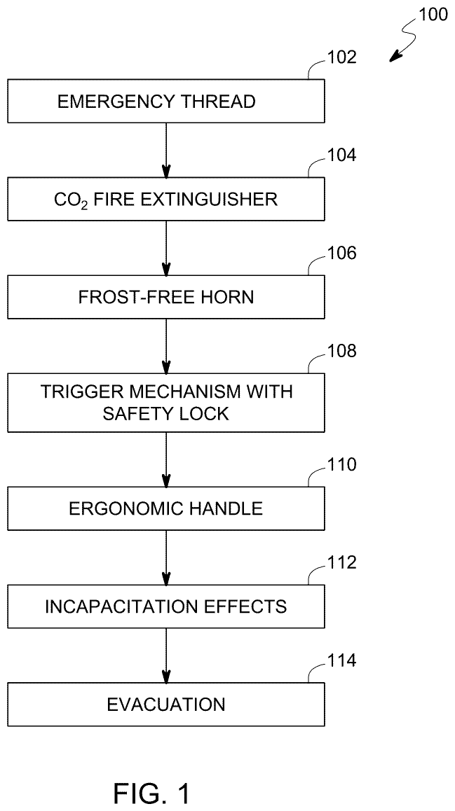

FIG. 2 is a block diagram in accordance with another exemplary embodiment of the invention;

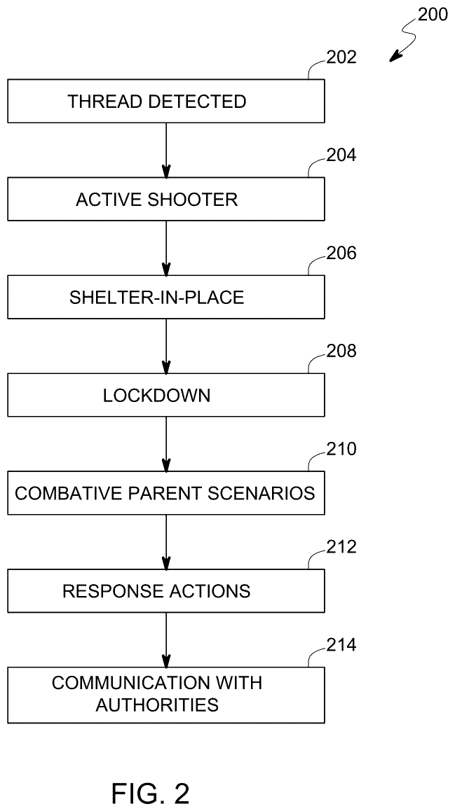

FIG. 3 is a system block diagram with a vehicle in accordance with another exemplary embodiment of the invention; and

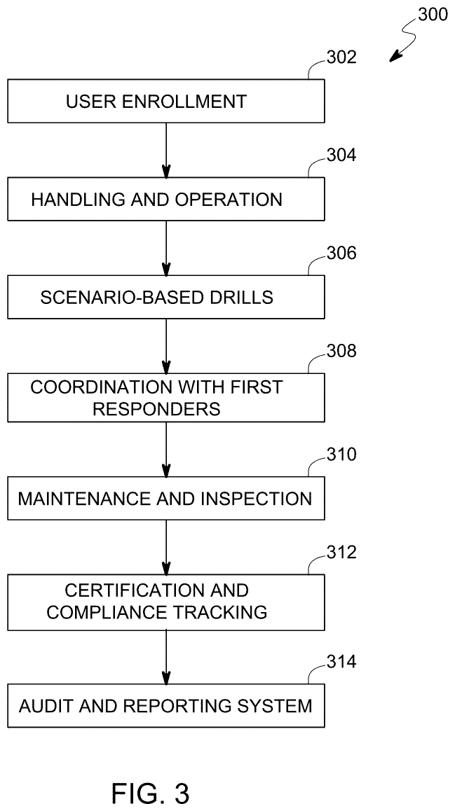

FIG. 4 is a block diagram in accordance with another exemplary embodiment of the invention;

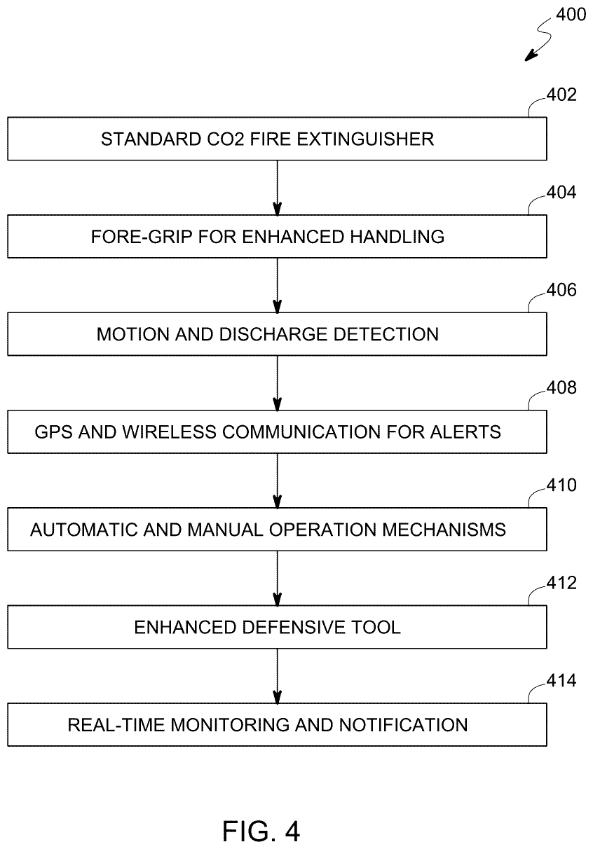

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

In an embodiment, the present invention includes a comprehensive non-lethal defense system using a 5-pound CO2 fire extinguisher and detailed training protocols. Upon discharge, the CO2 gas exits at −100° F. and travels at 50 feet per second, causing temporary blindness, hearing loss, frostbite, and oxygen displacement, incapacitating the intruder. The loud noise produced during discharge serves as a psychological deterrent. Staff training modules are tailored to address specific threats, including active shooters, shelter-in-place situations, lockdowns, and combative parent encounters.

In still another embodiment, the present invention includes a method for repurposing a 5-pound CO2 fire extinguisher as a non-lethal anti-intrusion device, complemented by integrated training protocols for use in various emergency situations. It delivers incapacitating effects, including disorientation, frostbite, and temporary sensory loss, offering critical time for staff to execute evacuation or lockdown procedures. The training system ensures staff proficiency across multiple scenarios, including active shooter threats and combative parent interventions.

In yet another embodiment, the present invention includes one or more components: a 5-Pound CO2 Fire Extinguisher: A standard fire extinguisher, repurposed for threat mitigation. Frost-Free Horn: Prevents frostbite on the user's hands during operation. Trigger Mechanism with Safety Lock: Allows for controlled bursts and prevents accidental discharge. Ergonomic Handle: Ensures secure grip and stability under stress.

In another embodiment, the present invention includes a cloud-based training system designed to teach and certify staff in a range of emergency procedures. The platform features scenario-based modules, interactive quizzes, and real-time progress tracking. Certification is granted only upon successful completion of all training modules, which is verified by passing the embedded quizzes.

In yet another embodiment, the present invention includes a system includes a backend feature that allows for the collection and storage of user data, including institutional details. This data is accessible to state authorities, who can log in to ensure compliance with mandated training requirements. The system generates certificates of completion and stores them for audit purposes.

In still another embodiment, the present invention includes the following deployment procedures:

### Deployment Procedures for Specific Threats

Active Shooter Exterior Threat
   Move children away from windows and entry points.
   Use the CO2 extinguisher to create visual and auditory barriers if the intruder breaches the perimeter.
   Coordinate with law enforcement and initiate evacuation as feasible.
Active Shooter Interior Threat
   Aim the extinguisher at the intruder's upper body or face, using short bursts to incapacitate.
   Maintain visibility of the threat while guiding children to exits.
   Deploy bursts strategically to keep the intruder at a distance during evacuation.
Shelter-in-place Situations
   If evacuation is impossible, use the extinguisher to incapacitate intruders attempting to enter the shelter.
   Keep radios accessible for ongoing communication and instructions.
   Maintain the extinguisher in a ready position for further use if needed.
Lockdown Procedures
   Use the CO2 extinguisher at entry points if the intruder tries to breach locked doors.
   Create a noise deterrent to disorient the intruder and buy time for further security measures.
   Coordinate movement to secondary safe zones if necessary.
Combative Parent Scenarios
   Retrieve the extinguisher in the event of aggressive behavior linked to custody disputes or legal restrictions.
   Discharge bursts toward the individual's face to incapacitate and prevent escalation.
   Monitor the situation while waiting for law enforcement to arrive.

In yet another embodiment, the present invention includes the following training and safety protocols:

### Training and Safety Protocols

Training Modules
   1. Handling and Operation: Grip, aiming techniques, and controlled burst usage.
   2. Maintenance and Inspection: Monthly inspections for pressure levels and refilling after use.
   3. Scenario-Based Drills: Simulations of active shooter and combative parent situations.
   4. Coordination with First Responders: Communication protocols with law enforcement.
   5. Post-Event Procedures: Refilling and inspecting the extinguisher to ensure readiness.
Regular Drills
   Drills include both active shooter and shelter-in-place scenarios to maintain staff proficiency.
   Evacuation simulations involve children to ensure smooth execution in real emergencies.

In another embodiment, the present invention includes a fore-grip specially suited and configured to mount upon a tank-style fire-extinguisher for use as a defensive tool, the fore-grip including a handle that mounts near the base or bottom-end of the extinguisher tank. A tank bracket is attached to the tank of the fire extinguisher with the fore-grip mounted to the bracket, which can include a clip for the extinguisher nozzle. A user is able to concurrently grasp the handle of the fore-grip to lift and to lift and aim the fire-extinguisher, while opening the manual valve to discharge the pressurized propellant from the nozzle.

In still another embodiment, the present invention includes a fire extinguisher comprising a fire extinguishing agent; a first mechanism configured to operate said fire extinguisher via a manual operation; a second mechanism configured to operate said fire extinguisher automatically; and wherein said fire extinguisher comprises at least one detector to detect the existence of a fire and cause the operation of said second mechanism.

In yet another embodiment, the present invention includes a system for notifying when a fire extinguisher is discharged or moved uses a device mounted on the fire extinguisher for monitoring one or more conditions. For example, the device may be interconnected with a trigger detecting mechanism otherwise present on the extinguisher or sense a sudden drop in pressure to detect when the extinguisher is activated. An accelerometer may be provided to detect motion. GPS processing can identify the location of the fire extinguisher when an event occurs. When the device detects a change in one or more of the conditions, or needs to send periodic updates of the fire extinguisher conditions, a message is forwarded from the device to a third party clearinghouse via a wireless communication network. The clearinghouse reviews the data, and forwards the data, as may be appropriate, to one or more authorized parties identified in the database.

In still another embodiment, the present invention includes a

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A comprehensive non-lethal defense system using a 5-pound CO2 fire extinguisher and detailed training protocols comprising: a standard fire extinguisher that is repurposed for threat mitigation; a frost-free horn that prevents frostbite on the hands of the user during operation the standard fire extinguisher; a trigger mechanism with a safety lock that allows for controlled bursts and prevents accidental discharge from the standard fire extinguisher; and an ergonomic handle that ensures secure grip and stability under stress corresponding the standard fire extinguisher.

2. The system of claim 1, wherein the system includes integrated training protocols for use in various emergency situations.

3. The system of claim 1, wherein the system ensures staff proficiency across multiple scenarios.

4. The system of claim 1, wherein the system delivers incapacitating effects.

5. The system of claim 1, wherein the incapacitating effects includes disorientation.

6. The system of claim 1, wherein the incapacitating effects includes frostbite.

7. The system of claim 1, wherein the incapacitating effects includes temporary sensory loss.

8. A comprehensive non-lethal defense system using a 5-pound CO2 fire extinguisher and detailed training protocols comprising: a standard fire extinguisher that is repurposed for threat mitigation; a frost-free horn that prevents frostbite on the hands of the user during operation of the standard fire extinguisher; a trigger mechanism with a safety lock that allows for controlled bursts and prevents accidental discharge from the standard fire extinguisher; and an ergonomic handle that ensures secure grip and stability under stress corresponding the standard fire extinguisher.

9. The device of claim 8, wherein the device includes integrated training protocols for use in various emergency situations.

10. The device of claim 8, wherein the device ensures staff proficiency across multiple scenarios.

11. The device of claim 8, the device delivers incapacitating effects.

12. The device of claim 8, wherein the incapacitating effects includes disorientation.

13. The device of claim 8, wherein the incapacitating effects includes frostbite.

14. The device of claim 8, wherein the incapacitating effects includes temporary sensory loss.
